(19) United States
(12) Patent Application Publication
(10) Pub. No.: US 2025/0376337 A1
(43) Pub. Date: Dec. 11, 2025

(54) AUTOFEEDER AND SYSTEM

(71) Applicant: Clear IP Corporation, Stafford, TX (US)

(72) Inventor: Jeff WU, Stafford, TX (US)

(73) Assignee: Clear IP Corporation, Stafford, TX (US)

(21) Appl. No.: 19/230,755

(22) Filed: Jun. 6, 2025

Related U.S. Application Data
(60) Provisional application No. 63/657,567, filed on Jun. 7, 2024.

(51) Int. Cl. B65G 47/14

(52) U.S. Cl. CPC B65G 47/145

(57) ABSTRACT

An autofeeder is provided. The autofeeder includes a bowl, a track, a feeding component, and a vibrating mechanism. The bowl is operable to receive a plurality of containers. The track extends along an inner wall of the bowl. The track is operable to receive the containers in a single file. The feeding component is operable to receive the containers from the track and dispense one container at a time to an assembly. The vibrating mechanism is operable to cause the bowl to vibrate such that the containers received therein move to have the same orientation.

### CROSS-REFERENCE TO RELATED APPLICATION

This application claims the benefit of U.S. Provisional Patent Application No. 63/657,567, filed in the U.S. Patent and Trademark Office on Jun. 7, 2024, which is incorporated herein by reference in its entirety for all purposes.

### TECHNICAL FIELD

The present disclosure relates generally to systems and techniques for sorting, orienting, align, and/or feeding containers.

### BACKGROUND

Since the legalization of hemp and related products in the USA many formants of consumption have arisen. Vaporization, edibles, and topicals are all delivery methods for ingestion. The creation of hemp and related concentrates have created a market for high potency products that can either be pyrolyzed or ingested which are particularly popular for medical and chronic pain patients. This market demand has created a supply chain struggling to supply products due to the difficult and often hard-to-package concentrate product that is sold by the gram.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof, which are illustrated in the appended drawings. Understand that these drawings depict only exemplary embodiments of the disclosure and are not, therefore, to be considered to be limiting of its scope, the principles herein are described and explained with additional specificity and detail through the use of the accompanying drawings in which:

FIG. 1A is a front view of an example system including an autofeeder;

FIG. 1B is a top view of the autofeeder;

FIG. 2A is a front view of a system with an autofeeder and a labeling assembly;

FIG. 2B is a top view of the system of FIG. 2A;

FIG. 2C is a front view of the system of FIG. 2A;

FIG. 2D is a left view of the system of FIG. 2A; and

FIG. 3A shows the autofeeder in operation;

FIG. 3B shows the autofeeder as the containers move along a track and into a feeding component;

FIG. 3C shows the autofeeder as the containers move along the track and into the feeding component;

FIG. 3D shows the autofeeder, showing the containers move along the feeding component;

FIG. 3E shows the containers being dispensed from the feeding component onto a conveyor for the labeling assembly;

FIG. 3F shows an application component of the labeling assembly;

FIG. 3G shows the application component applying a label on a container as the container moves along via the conveyor;

FIG. 3H shows the containers with the labels applied thereon moving along via the conveyor;

FIG. 3I shows the containers with the labels reaching a dispensing portion of the labeling assembly; and

FIG. 3J shows a container being deposited into a receptacle from the dispensing portion of the labeling assembly.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure. Additional features and advantages of the disclosure will be outlined in the description which follows, and in part will be obvious from the description, or can be learned by practice of the herein disclosed principles. It will be appreciated that for simplicity and clarity of illustration, where appropriate, reference numerals have been repeated among the different figures to indicate corresponding or analogous elements. The description is not to be considered as limiting the scope of the embodiments described herein.

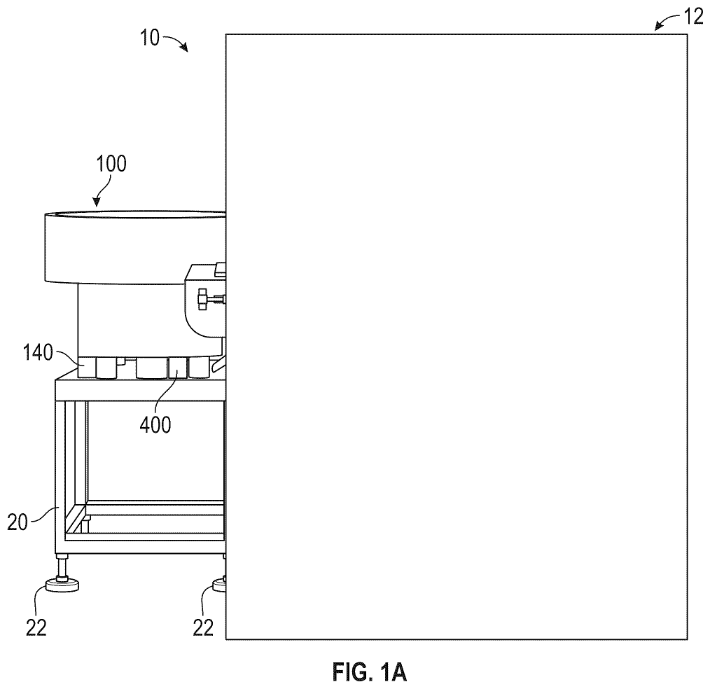

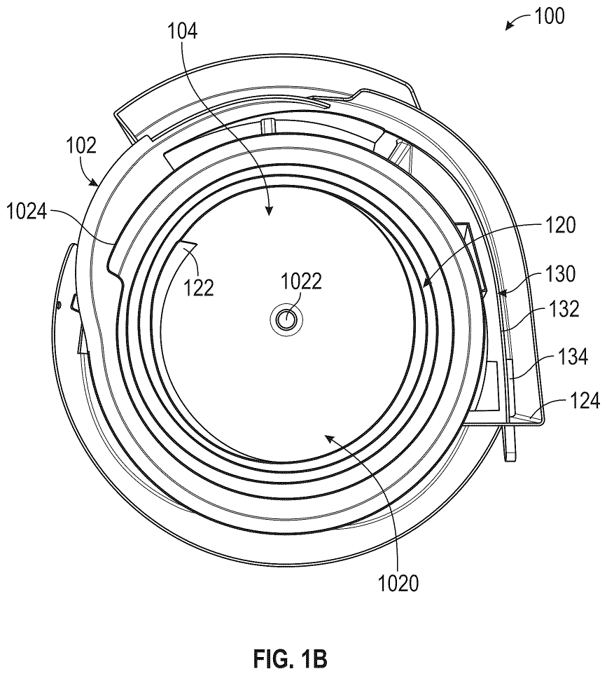

FIG. 1A illustrates an example system 10. The system 10 can include an autofeeder 100 and an assembly 12. The autofeeder 100 is operable to receive a plurality of containers. The autofeeder 100 is then operable to orient, align, and/or feed the containers to the assembly 12 in the desired orientation so that the assembly 12 to automatically perform actions on or with the containers automatically without the need of user input or assistance.

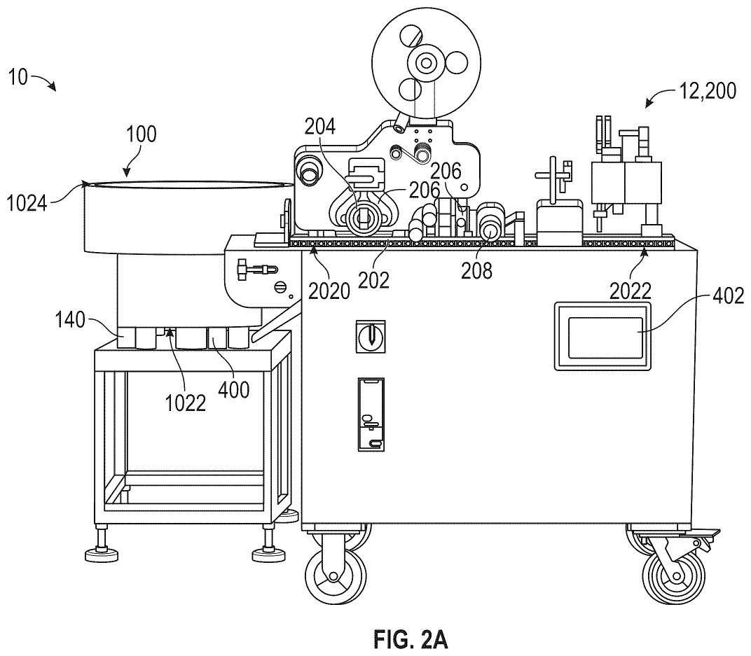

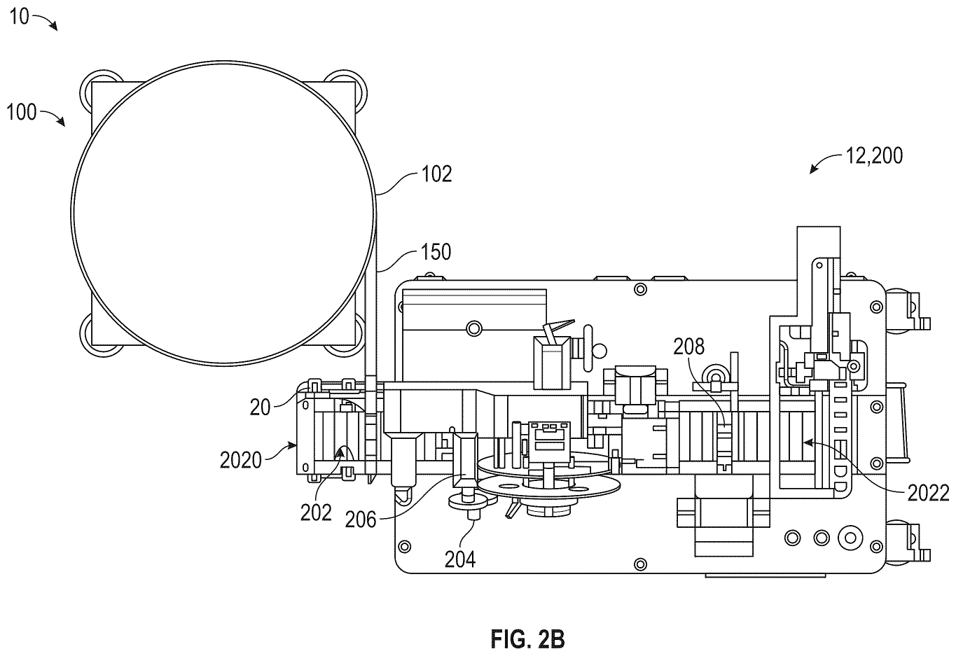

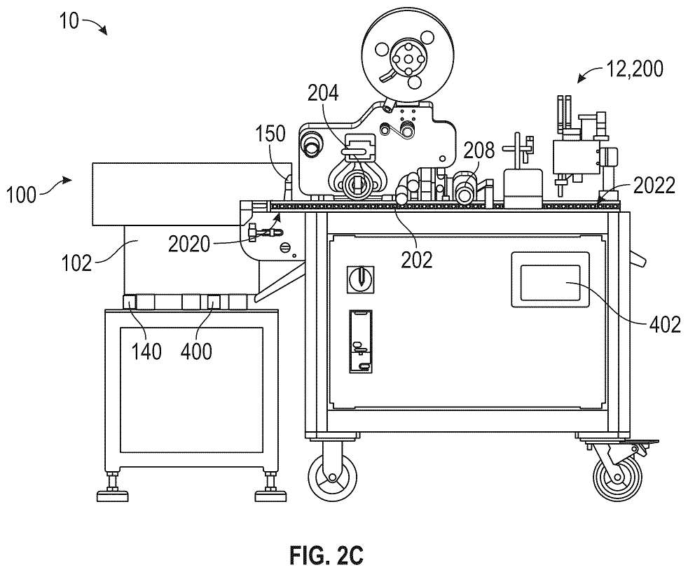

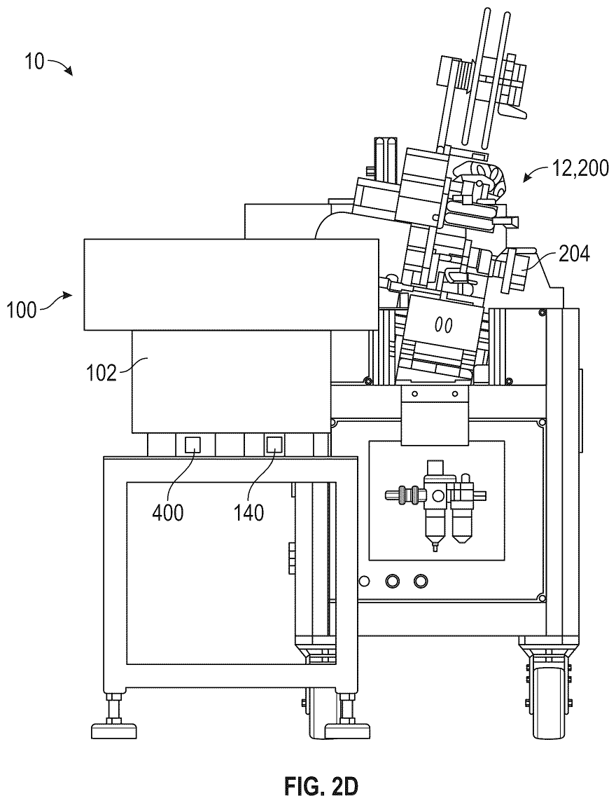

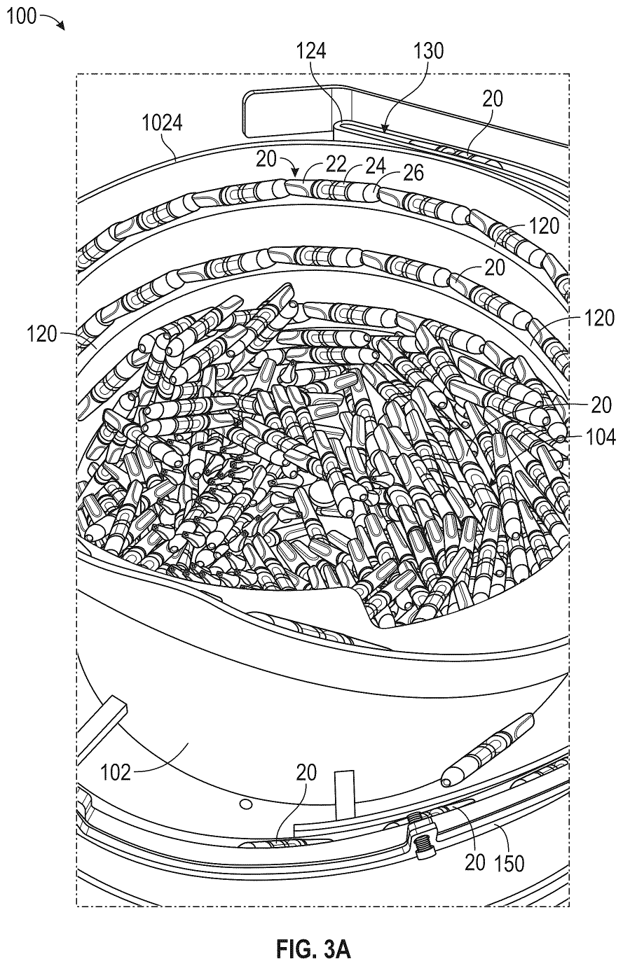

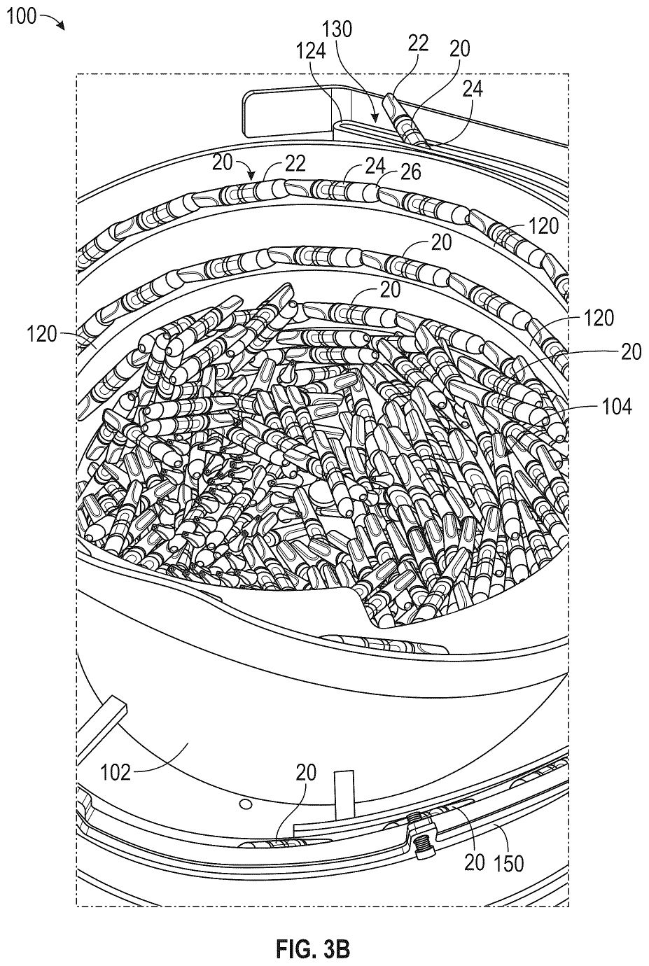

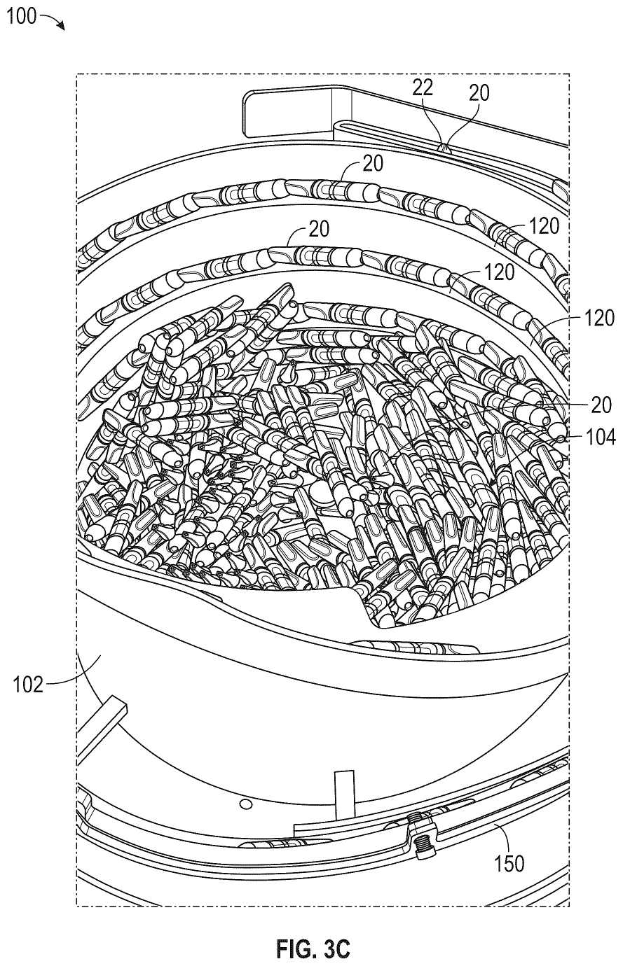

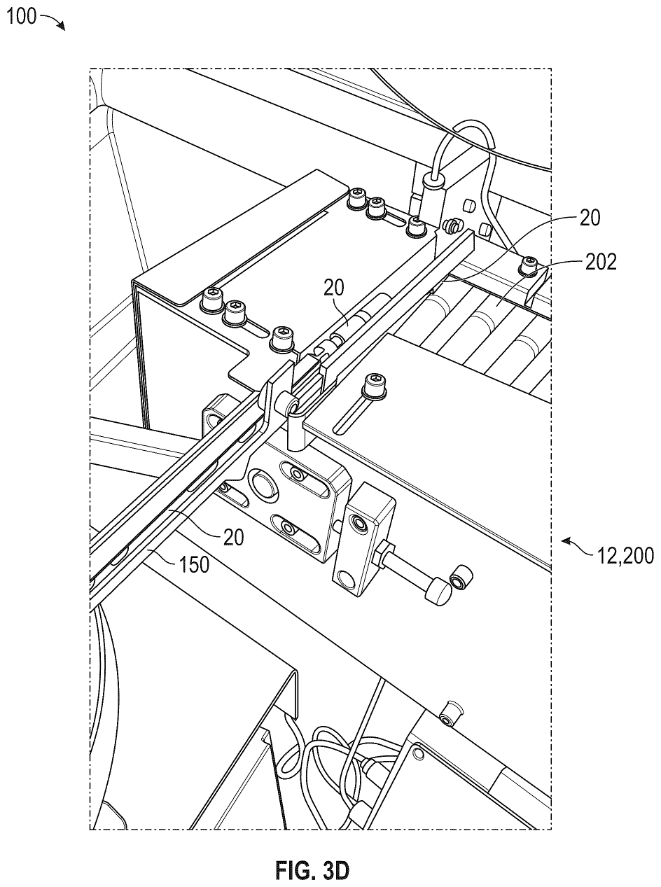

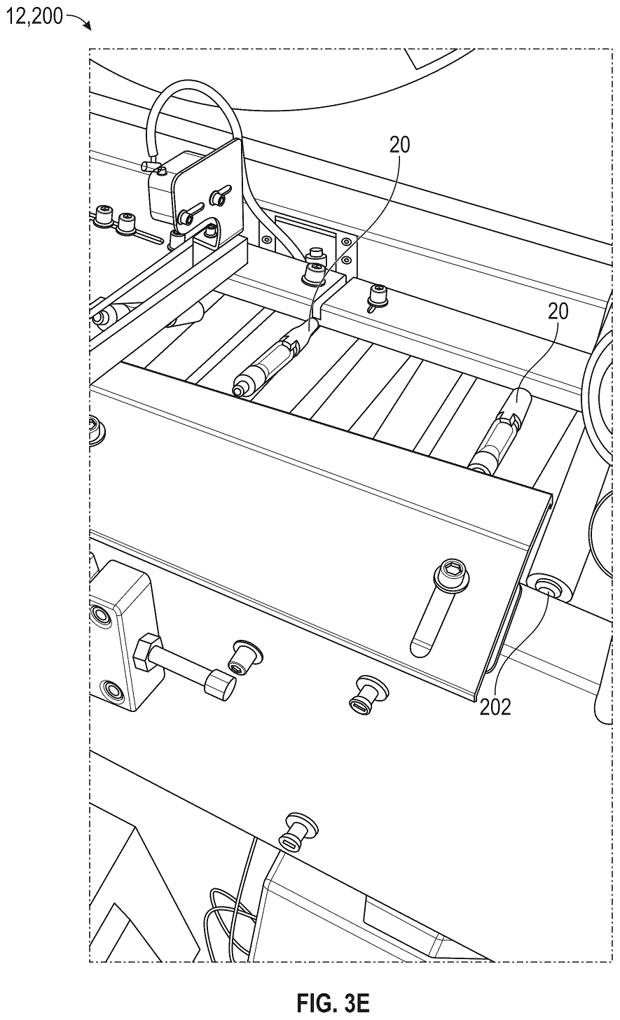

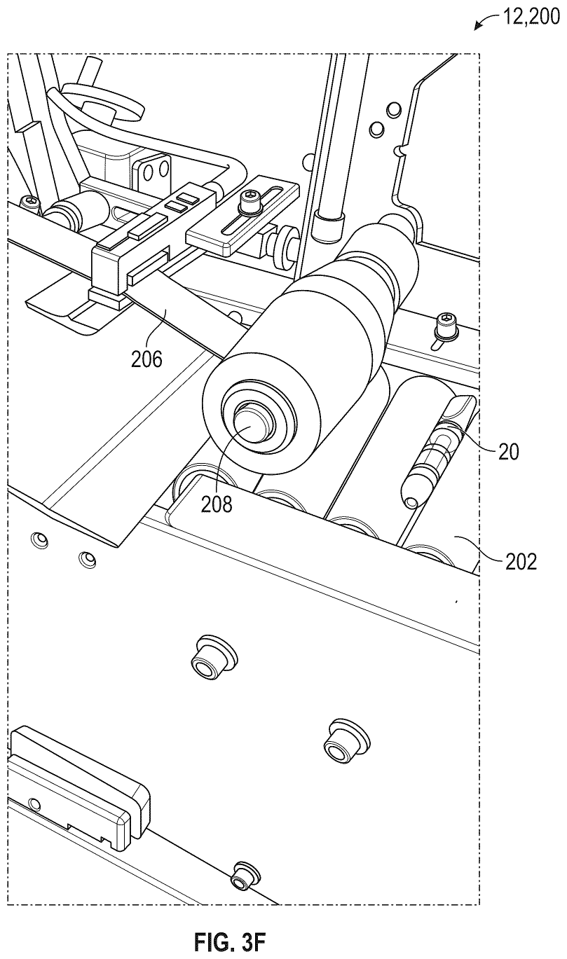

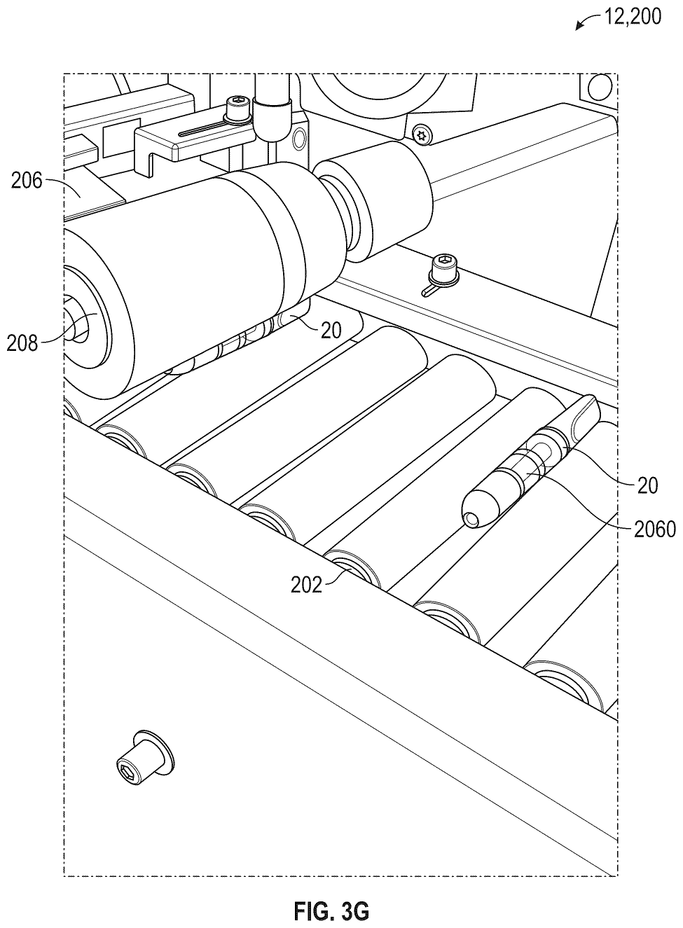

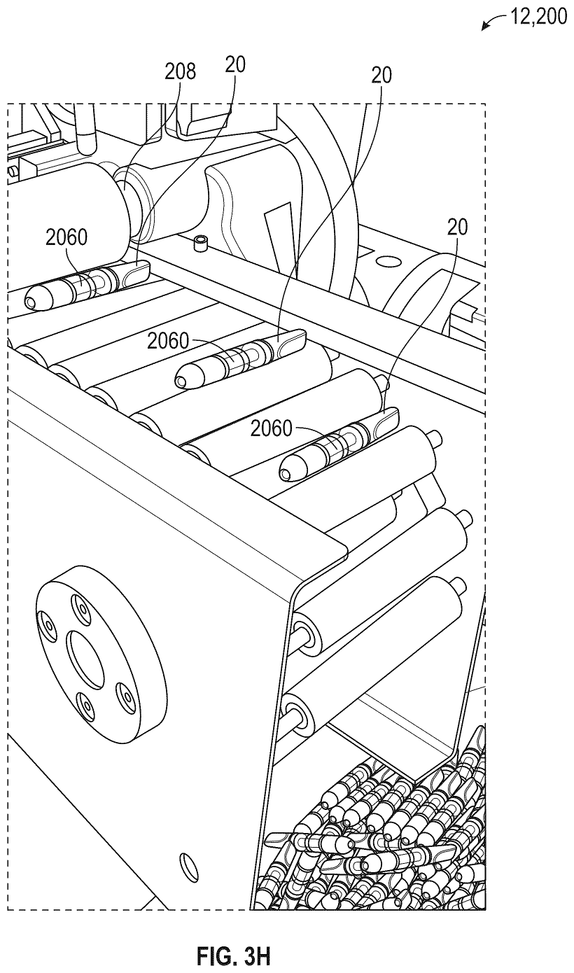

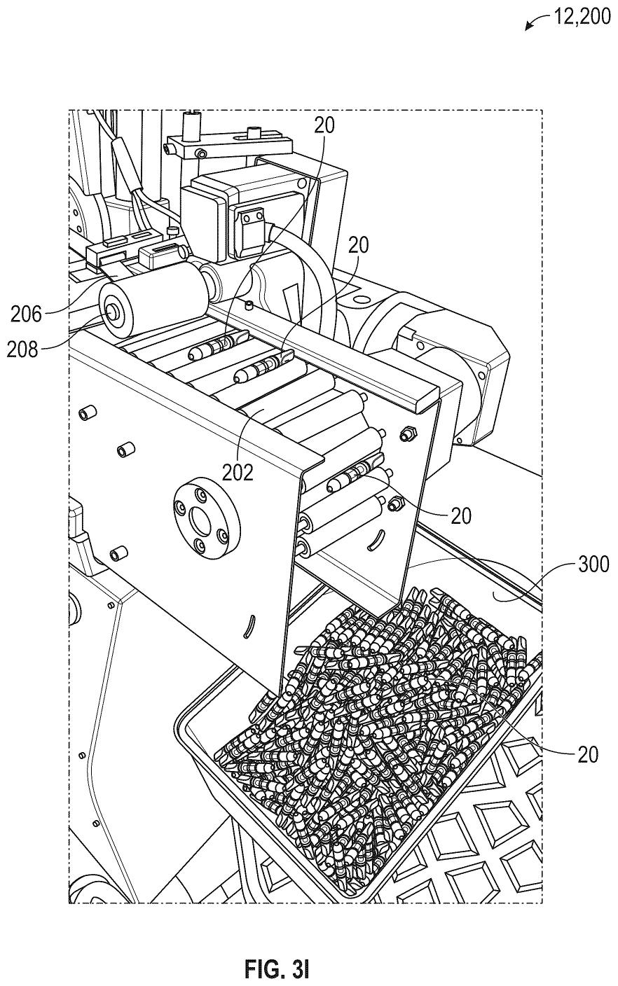

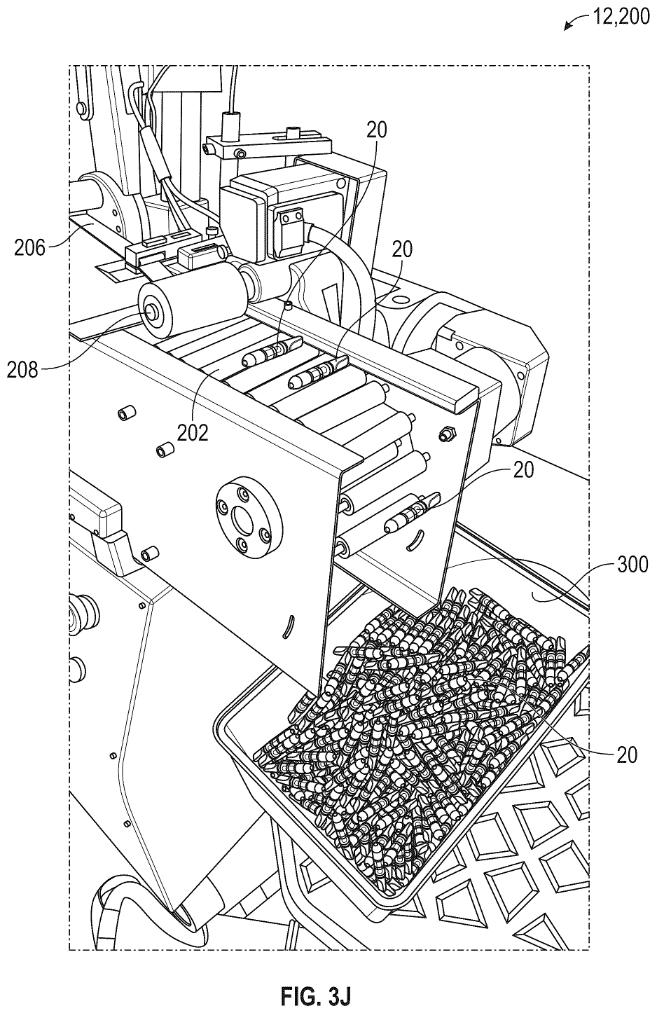

In at least one example, as illustrated in FIGS. 2A-3J, the assembly 12 can include a labeling assembly 200 operable to place a label 2060 on each of the plurality of containers. While the disclosure herein discusses the assembly 12 including a labeling assembly 200, different types of assemblies 12 in manufacturing, preparing, and/or packaging the containers can be utilized without deviating from the disclosure. In some examples, the assembly 12 can include a boxing assembly operable to place the plurality of containers in a corresponding shipping receptacle. In some examples, the assembly 12 can include a printing assembly operable to print one or more images and/or text on each of the plurality of containers The printing assembly can be operable to UV print the one or more images and/or text on each of the containers. The printing assembly can be operable to use ink or any other suitable marking mechanism on the containers. In some examples, the assembly 12 can include a printing assembly operable to print one or more images and/or text on each of the plurality of containers. In some examples, the assembly 12 can include a packaging assembly operable to place each of the containers in a corresponding one of a plurality of packaging receptacles. In some examples, the assembly 12 can include a cleaning assembly operable to clean the containers.

With each or any assembly 12, the containers need to be fed to the assembly in a desired orientation. Additionally, in at least one example, the containers need to be fed to the assembly one at a time. The autofeeder 100 is operable to automatically sort, orient, align, and/or feed the containers one at a time to the assembly 12 as needed for the assembly 12 to then perform the actions on or with the containers.

For example, as illustrated in FIG. 1B, the autofeeder 100 can include a bowl 102 operable to receive the plurality of containers 20 (for example, shown in FIGS. 3A-3J). For example, the bowl 102 can be operable to receive up to 2,000 containers 20 at a time. In some examples, the bowl 102 can be operable to receive up to 10,000 containers 20 at a time. The autofeeder 100 can then orient, align, and feed all of the containers 20 received in the bowl 102 to the assembly 12 without the need for additional user assistance. This can greatly reduce the man-power needed and the cost of the manufacture and preparation of the containers 20. Additionally, the autofeeder 100 can ensure optimal performance and efficiency of the system 10. In at least one example, the bowl 102 can include plastic. In some examples, the bowl 102 can include metal, such as stainless steel. The bowl 102 can form a receiving portion 104 which is operable to receive and contain the containers 20 to be sorted, oriented, aligned, and/or fed to the assembly 12. The bowl 102 can have an inner wall 1020 that spans between a bottom surface 1022 and a top surface 1024. The bottom surface 1022 can be the bottom of the receiving portion 104 while the top surface 1024 can be the inner wall 1020 opposite the bottom surface 1022.

The shape of the bowl 102 is important to effectively orient, align, and feed the containers 20. The inner surface 1020 of the bowl 102 can have a conical shape such that the inner surface 1020 slopes upwards towards the top surface 1024. Accordingly, the inner surface 1020 can slope from the bottom surface 1022 towards the top surface 1024. The conical shape helps concentrate the components towards the outer edge of the bowl 102, facilitating the movement of the containers 20 upwards towards the top surface 1024. The conical shape of the inner surface 1020 can also help prevent jamming and ensures a smooth flow of containers 20 as the containers 20 move within the autofeeder 100 towards the assembly 12.

In at least one example, as illustrated herein, the bowl 102 can include a track 120 extending along the inner wall 1020 of the bowl 102. The track 120 can traverse from a start 122 proximate the bottom surface 1022 of the bowl 102 towards an end 124 towards or proximate the top surface 1024 of the bowl 102. The track 120 can be operable to receive the containers 20 in a single file. The track 120 can then guide the containers 20 in the desired orientation towards the feeding component 150. In at least one example, the track 120 can have a continuous helical shape about the inner surface of the bowl 102. In some examples, the track 120 can extend along the inner wall 1020 of the bowl 102 in a spiral configuration. While the disclosure herein discusses the use of one track 120, in some examples, two or more tracks 120 can be utilized without deviating from the scope of the disclosure.

In at least one example, the autofeeder 100 can include a vibrating mechanism 140 operable to cause the bowl 102 to vibrate such that the containers 20 received therein move to have the same orientation. The vibrating mechanism 140 can also cause the containers 20 to move towards the upper surface 1024 of the bowl 102 towards a feeding component 150 (shown in FIGS. 2B, 2C, and 3A-3D) which is operable to dispense the containers 20 to the assembly 12.

In at least one example, the vibrating mechanism 140 can be coupled with or abutting against the bowl 102 such that the vibrating mechanism 140 can cause at least a portion of the bowl 102 to vibrate. In at least one example, to create the vibrations, the vibrating mechanism 140 can include a motor. In at least one example, to create the vibrations, the vibrating mechanism 140 can include one or more electromagnets such that the vibrating mechanism 140 converts electromagnetically produced vibrations into mechanism vibrations. In some examples, the vibrating mechanism 140 can include between 1 and 6 electromagnets positioned under the bowl 102. In at least one example, the bowl 102 can be spring mounted so that the bowl 102 can move and/or vibrate as desired to manipulate the containers 20. For example, a magnetic coil can be fixed beneath the spring-mounted bowl 102. The coil can be magnetized through a power source to create an electromagnetic actuation (e.g., vibration). The spring mounting of the bowl 102 limits the vertical movement of the bowl 102. As the electromagnetic vibrations are converted to mechanical vibrations, the vibrations move the containers 20 in the receiving portion 104 of the bowl 102 onto the track 120 for production. As the containers 20 vibrate within the bowl 102, the containers 20 tend to move upwards along the inner wall 1020 of the bowl towards the top surface 1024. Accordingly, the vibrating mechanism 140 is operable to cause the track 120 to vibrate such that the containers 20 received thereon traverse along the track 120 from the start 122 to the ends 124.

In at least one example, the autofeeder 100 can include a controller 400 in communication with the vibrating mechanism 140. The controller 400 can be operable to control a frequency, a pattern, and/or an amplitude of the vibrations caused by the vibrating mechanism 140. The frequency, the pattern, and/or the amplitude can be adjustable based on the size, shape, weight, and/or weight distribution (e.g., center of gravity) of the containers 20. In some examples, the controller 400 can receive input from an operator regarding the desired frequency, pattern, and/or amplitude of the vibrations. In some examples, the controller 400 can receive input from an operator regarding the properties (e.g., the type, shape, weight, etc.) of the containers 20, and the controller 400 can determine the frequency, pattern, and/or amplitude of the vibrations needed to orient, align, and/or feed the containers 20 within the autofeeder 100. In some examples, the controller 400 can be in communication with one or more sensors (e.g., camera) and can determine the movement of the containers 20 within the autofeeder 100. The controller 400 can then adjust the vibrations caused by the vibrating component 140 to more efficiently and effectively orient, align, and/or feed the containers 20 to the assembly 12 as desired. After the controller 400 makes the determination of the frequency, pattern, and/or amplitude of the vibrations that best move the containers 20 as desired, the controller 400 can cause the vibrating component 140 to create the desired vibrations for the bowl 102.

In some examples, the controller 400 can apply machine learning, such as a neural network or sequential logistic regression and the like, to determine relationships between the autofeeder 100 and the containers 20. For example, a deep neural network may be trained in advance to capture the complex relationship between the vibrating mechanism 140, the movement of the containers 20 within the bowl 102, on the track 120, and/or on the feeding component 150. This neural net can then be deployed in the control of the frequency, pattern, and/or amplitude of the vibrations of the bowl 102, the track 120, and/or the feeding component 150 caused by the vibrating mechanism 140. As such, the desired orientation, alignment, and movement of the containers 20 can be as desired.

The movement of the containers 20 upwards along the inner wall 1020 of the bowl 102 can be caused by a combination of centrifugal force, friction, angle of inclination, vibration pattern, vibration frequency, and/or vibration amplitude. Regarding centrifugal force, as the bowl 102 vibrates, the vibrations create a centrifugal force that pushes the containers 20 towards the outer edge (e.g., top surface 1024) of the bowl 102. This force causes the containers 20 to move upwards along the inner wall 1020 of the bowl 102 as the bowl 102 has a conical shape. Regarding friction, when the containers 20 make contact with the inner surface 1020 of the bowl 102, the containers 20 tend to adhere to the surface 1020 of the bowl 102. As the bowl 102 vibrates, this frictional force, combined with the centrifugal force, propels the containers 20 upwards. Regarding angle of inclination, the bowl 102 includes a slope at an angle. The slope can help facility the movement of the containers 20. The angle, combined with the vibration, encourages the containers 20 to move and climb upwards along the inner wall 1020. Regarding vibration pattern, frequency, and/or amplitude, the vibration generated by the vibrating mechanism 140 is designed to induce the desired motion of the containers 20. By adjusting the frequency and amplitude of the vibrations, the autofeeder 100 can control the movement of the containers 20 to ensure the containers 20 travel along the inner wall 1020 towards the assembly 12.

The mechanical vibrations are harnessed and then transferred to the track 120 of the bowl 102, which moves the containers 20 along the track 120 to feed the containers 20 into the assembly 12. Referring to FIG. 1B, the track 120 can include a drop feature 130. In at least one example, the drop feature 130 can be positioned proximate to, near, or at the end 124 of the track 120. The containers 20 can be operable to drop from the drop feature 130 of the track 120 to the feeding component 150 in the desired orientation. In at least one example, the containers 20 can drop from the drop feature 130 of the track 120 to the feeding component 150 one at a time. In at least one example, the drop feature 130 can include an aperture 132 formed in the track 120. The containers 20 can fall through the aperture 132 onto the feeding component 150 due to gravity. In at least one example, the drop feature 130 can include a tilt component 134 operable to abut against the container 20 as the container traverses towards the end of the track 120. The tilt component 134 can be operable to cause the container 20 to tilt such that the container 20 falls into the aperture 132 in the desired orientation.

Referring back to FIG. 1A, the autofeeder 100 can include a base 20 on which the bowl 102 can be received. For example, the bowl 102 can be received by and positioned on top of the base 20. In at least one example, the base 20 can be sized to be placed on a tabletop (not shown). The base 20 in other implementations can be floor mounted. The base 20 can function as a balancing base in that the base 20 serves to balance the components and provide some stability as the various components move and/or operate. In at least one example, the base 20 can include one or more transportation components 22 that permit the autofeeder 100 to be moved and/or repositioned. For example, the transportation components 22 can include wheels.

FIGS. 2A-2D illustrate the assembly 12 as the labeling assembly 200. The autofeeder 100 is operable to orient, align, and feed the containers 20 onto the labeling assembly 200 automatically without user input or assistance. The labeling assembly 200 is then operable to take each container 20 and place a label thereon automatically without user input or assistance. Accordingly, the system 10 can greatly reduce the man-power needed and the cost of the manufacture and preparation of the containers 20. Additionally, the system 10 can ensure optimal performance and efficiency.

As discussed above, the autofeeder 100 can orient, align, and feed the containers 20 onto the labeling assembly 200. The feeding component 150 of the autofeeder 100 can be operable to receive the containers 20 from the track 120 and can be operable to dispense one container 20 at a time to the assembly 12 (e.g., the labeling assembly 200). For example, the feeding component 150 can be operable to dispense the containers 20 one at a time in the desired orientation and alignment onto a conveyor 202 of the assembly 12, 200. In at least one example, the vibrating mechanism 140 can be operable to cause the feeding component 150 to vibrate such that the containers 20 received thereon move to be dispensed to the assembly 12. In some examples, the feeding component 150 can include a carrier operable to transport the containers 20 to the assembly 12. For example, the carrier can include a belt, a roller, a chain, a slat, etc.

The conveyor 202 can include a beginning portion 2020 and an end portion 2022. The conveyor 202 can be operable to translate the containers 20 from the beginning portion 2020 towards the end portion 2022 where the containers 20 can be removed from the assembly 12, 200. In at least one example, the conveyor 202 can include a conveyor belt that includes grooves, recesses, and/or spaces for the containers 20 to be received in. Therefore, the containers 20 remain oriented in the desired configuration and do not move unnecessarily to ensure that the assembly 12 can efficiently and effectively perform its needed actions on the containers 20.

The labeling assembly 200 can include a reel 204 that is operable to receive and dispense a roll 206 of labels 2060. An applicator 208 is positioned downhill (e.g., towards the end 2022) of the reel 204. The applicator 208 is operable to rotate and apply the label 2060 onto the container 20 as the container 20 translates via the conveyor 202. The rotation of the applicator 208 also causes the container 20 to rotate in position. As the container 20 rotates, the label 2060 can be applied onto the container 20 without bumps, bubbles, etc.

In at least one example, the labeling assembly 200 can include a controller 402 which can be operable to control the function (e.g., speed, movement, timing, etc.) of the components of the labeling assembly 200, such as the conveyor 202, the reel 204, and/or the applicator 208. The controller 402 can ensure that the labeling assembly 200 is efficiently and effectively applying the labels 2060 onto the containers 20 as desired, and without the need of operator input and/or assistance.

FIGS. 3A-3J illustrate the system 10 (e.g., the autofeeder 100 and the labeling assembly 200) in operation. As shown in FIGS. 3A-3C, the receiving portion 104 of the bowl 102 receives a plurality of containers 20. The containers 20, as illustrated in FIGS. 3A-3J, can include a cartridge configured for a vaporizer. As illustrated, the containers 20 can include a front portion 22 (e.g., a mouthpiece), a middle portion 24 (e.g., a receptacle for fluid), and an end portion 26 (e.g., a coupling mechanism to couple with a vaporizer). In some examples, the containers 20 can include a special purpose jar or a commercially available jar.

As shown in FIGS. 3A-3C, the receiving portion 104 of the bowl 102 can receive a large number of containers 20 at a time. For example, the receiving portion 104 can be configured to receive up to 2000 containers 20 at a time. In some examples, the receiving portion 104 can be configured to receive up to 10,000 containers 20 at a time. In some examples, depending on the size, shape, and ability to convey the vibrations to cause the movement of the containers 20, the receiving portion 104 can be configured to receive any desired number of containers 20 to lessen the amount of work that an operator needs to do.

As the bowl 102 vibrates due to the vibrating mechanism 140, the containers 20 move to orient themselves in the desired orientation and alignment. The containers 20 also then move towards the outer edge (e.g., the upper surface 1024) of the bowl 102, and are then received onto the track 120. The track 120 is configured such that only one container 20 can be received thereon width-wise. Accordingly, the containers 20 form a single file on the track 120. As the track 120 vibrates, the containers 20 move up the spiraled configuration of the track 120 up towards the upper surface 1024 of the bowl 102 towards the end 124 of the track 120.

As the containers 20 approach the end 124 of the track 120, the containers 20 reach the drop feature 130 of the track 120 so that the containers 20 are received by the feeding component 150 in the desired orientation. As shown in FIGS. 3B and 3C, the container 20 at the drop feature 130 tilts so that the end portion 26 of the container 20 drops through the aperture 132 first. In at least one example, this can be caused by the center of gravity of the container 20 as the end portion 26 can be heavier than the front portion 22 of the container 20. In some examples, the tilt component 134 can be configured such that the front portion 22 passes above the tilt component 134. The front portion 22 can have a slope such that the container 20 increases in width as the container 20 transitions towards the middle portion 24 and/or the end portion 26. Accordingly, the tilt component 134 may abut against the slope of the container 20 which causes the container 20 to tilt upwards, assisting the container 20 to drop through the aperture 132 onto the feeding component 150 in the desired orientation.

As shown in FIGS. 3A-3E, the feeding component 150 is operable to dispense the containers 20 one at a time to the assembly 12, 200. For example, the feeding component 150 can dispense the containers 20 one at a time onto the conveyor 202 of the assembly 12, 200. The orientation and alignment of the containers 20 as the feeding component 150 dispenses the containers 20 is critical, as the containers 20 must be received by the conveyor 202 of the assembly 12, 200 in the correct alignment and orientation, or the assembly 12, 200 may incorrectly manipulate the containers 20. For example, as illustrated herein with a labeling assembly 200, if the autofeeder 100 did not orient and align the containers 20 correctly, the labeling assembly 200 may place the label 2060 onto the container 200 incorrectly.

As illustrated in FIGS. 3F-3H, the applicator 208 of the labeling assembly 200 is operable to apply the label 2060 from the roll 206 onto the container 20. The applicator 208 rotates or spins which causes the container 20 to also rotate or spin in place on the conveyor 202. As the container 20 rotates, the applicator 208 places the label 2060 onto the container 20.

As illustrated in FIGS. 3I and 3J, after the containers 20 receive the labels 2060, the conveyor 202 continues moving the containers 20 towards the end 2022 of the conveyor 202, where the containers 20 can be removed from the assembly 12 at a dispensing portion of the assembly 12. For example, as illustrated in FIGS. 3I and 3J, the dispensing portion of the conveyor 202 can form a curve so that the containers 20 fall out of the slot, groove, recess, space, etc. of the conveyor 202. In some examples, the dispensing portion of the conveyor 202 can include a grasper that picks up the containers 20. Other suitable dispensing mechanisms can be utilized without deviating from the scope of the disclosure.

In at least one example, as illustrated in FIGS. 3I and 3J, the containers 20 can be dispensed into a receptacle 300. The receptacle 300 can be operable to receive the containers 20 so that the containers 20 can be brought to another assembly 12 or system 10. In some examples, the containers 20 can be dispensed onto another assembly 12 in the production line. In some examples, the containers 20 can be dispensed into another autofeeder 100 to orient, align, and feed the containers 20 into another assembly 12.

While examples of the present inventive concept have been shown and described herein, it will be obvious to those skilled in the art that such examples are provided by way of example only. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

What is claimed is:

1. An autofeeder comprising:
a bowl operable to receive a plurality of containers;
a track extending along an inner wall of the bowl that traverses from a start proximate a bottom surface of the bowl towards an end towards or proximate a top surface of the bowl, wherein the track is operable to receive the plurality of containers in a single file;
a feeding component operable to receive the plurality of containers from the track, the feeding component operable to dispense one container of the plurality of containers at a time to an assembly,
wherein a vibrating mechanism is operable to cause the bowl to vibrate such that the plurality of containers received therein move to have a same orientation.

2. The autofeeder of claim 1, wherein the vibrating mechanism is operable to cause the track to vibrate such that the plurality of containers received thereon traverse along the track from the start to the end.

3. The autofeeder of claim 1, wherein the vibrating mechanism is operable to cause the feeding component to vibrate such that the plurality of containers received thereon move to be dispensed to the assembly.

4. The autofeeder of claim 1, wherein a controller is in communication with the vibrating mechanism, wherein the controller is operable to control a frequency, a pattern, and/or an amplitude of the vibrations caused by the vibrating mechanism, wherein the frequency, the pattern, and/or the amplitude is adjustable based on a size, shape, weight, and/or weight distribution of the plurality of containers.

5. The autofeeder of claim 1, wherein inner wall of the bowl slopes from the bottom surface towards the top surface.

6. The autofeeder of claim 1, wherein the track extends along the inner wall of the bowl in a spiral configuration.

7. The autofeeder of claim 1, wherein the track includes a drop feature, wherein the plurality of containers are operable to drop from the drop feature of the track to the feeding component.

8. The autofeeder of claim 7, wherein the drop feature includes an aperture formed in the track, wherein the plurality of containers fall through the aperture due to gravity.

9. The autofeeder of claim 8, wherein the drop feature includes a tilt component operable to abut against the plurality of containers as the plurality of containers traverse towards the end of the track, wherein the tilt component is operable to cause the plurality of containers to tilt such that the plurality of containers fall into the aperture in a desired orientation.

10. The autofeeder of claim 1, wherein the feeding component includes a carrier operable to transport the plurality of containers to the assembly.

11. The autofeeder of claim 1, wherein the vibrating mechanism includes a motor.

12. The autofeeder of claim 1, wherein the vibrating mechanism includes one or more electromagnets such that the vibrating mechanism converts electromagnetically produced vibrations into mechanical vibrations.

13. The autofeeder of claim 1, wherein the bowl is spring-mounted.

14. A system comprising:
an autofeeder including:
a bowl operable to receive a plurality of containers;
a track extending along an inner wall of the bowl that traverses from a start proximate a bottom surface of the bowl towards an end towards or proximate a top surface of the bowl, wherein the track is operable to receive the plurality of containers in a single file;
a feeding component operable to receive the plurality of containers from the track, the feeding component operable to dispense one container of the plurality of containers at a time to an assembly,
wherein a vibrating mechanism is operable to cause the bowl to vibrate such that the plurality of containers received therein move to have a same orientation; and
an assembly operable to receive the plurality of containers from the feeding component.

15. The system of claim 14, wherein the assembly includes a labeling assembly operable to place a label on each of the plurality of containers.

16. The system of claim 14, wherein the assembly includes a boxing assembly operable to place the plurality of containers in a corresponding shipping receptacle.

17. The system of claim 14, wherein the assembly includes a printing assembly operable to print one or more images and/or text on each of the plurality of containers.

18. The system of claim 17, wherein the printing assembly is operable to UV print the one or more images and/or text on each of the plurality of containers.

19. The system of claim 14, wherein the assembly includes a packaging assembly operable to place each of the plurality of containers in a corresponding one of a plurality of packaging receptacles.

20. The system of claim 14, wherein the assembly includes a cleaning assembly operable to clean the plurality of containers.
